(19) United States
(12) Patent Application Publication
(10) Pub. No.: US 2013/0106558 A1
(43) Pub. Date: May 2, 2013

(54) COIL COMPONENT AND MANUFACTURING METHOD THEREOF

(71) Applicant: TMP International Corporation, New Taipei City (TW)

(72) Inventors: Ming-Chi CHEN, New Taipei City (TW); Wen-Pin CHEN, New Taipei City (TW)

(73) Assignee: TMP INTERNATIONAL CORPORATION, New Taipei City (TW)

(21) Appl. No.: 13/666,782

(22) Filed: Nov. 1, 2012

(30) Foreign Application Priority Data
Nov. 1, 2011 (TW) 100139689
Nov. 1, 2011 (TW) 100220508

(51) Int. Cl. H01F 17/04; H01F 41/06

(52) U.S. Cl. 336/221; 29/605

(57) ABSTRACT

A manufacturing method of a coil component comprises the steps of: providing a first permeance element; sticking a strip-like element to a first area of a first surface of the first permeance element; providing a second permeance element; disposing a winding structure between the first permeance element and the second permeance element, or around at least one of the first permeance element and the second permeance element; and connecting the first permeance element and the second permeance element by a connecting material stuck to a second area, which is without the strip-like element, of the first surface.

### CROSS REFERENCE TO RELATED APPLICATIONS

This Non-provisional application claims priority under 35 U.S.C. §119(a) on Patent Application No(s). 100139689 and 100220508 filed in Taiwan, Republic of China on Nov. 1, 2011 and Nov. 1, 2011, the entire contents of which are hereby incorporated by reference.

### BACKGROUND OF THE INVENTION

1. Field of Invention

The invention relates to a coil and a manufacturing method thereof and, in particular, to a coil component and a manufacturing method thereof.

2. Related Art

The coil component is a fundamental electronic device that has been widely used. It can be used as an inductor, or an electromagnetic winding coil of a transformer or a motor.

As shown in FIGS. 1A and 1B, in the manufacturing method of a conventional coil component 1, a coil base 11 is formed with a recess 111 and two openings 112 and 113. A coil 12 is disposed in the recess 111, and has a first end 121 and a second end 122. The first end 121 and the second end 122 are extended outwards through the openings 112 and 113 respectively to serve as two pins of the coil component 1. Then, the magnetic powder is disposed on the coil base 11 and formed by die-casting to become a magnetic body 13. However, for the manufacturing method as mentioned above, the coil base 11 and the coil 12 need to be made in advance, and then are put into a mold, in which the magnetic body 13 is formed by die-casting. So, the coil base 11 and the magnetic body 13 can not be prepared respectively in advance.

Otherwise, in order to simplify the manufacturing process, the coil base 11 and the magnetic body 13 can be made in advance, then the coil 12 is disposed in the recess 111, and the magnetic body 13 and the coil base 11 are adhered to each other by a resin. After being made, the coil component 1 can be soldered onto a circuit board to cooperate with other components or circuits on the circuit board. However, when the circuit board operates, the magnetic body 13 and the coil base 11 will bear the alternate attraction and repulsion repeatedly due to the electromagnetic field, so that they will collide with each other repeatedly to make the noise. The noise problem will not be solved even though the resin connecting the magnetic body 13 and the coil base 11 is thickened.

Therefore, it is an important subject to provide a coil component and a manufacturing method thereof that have advantages of less noise and more simplified structure.

### SUMMARY OF THE INVENTION

In view of the foregoing subject, an objective of the invention is to provide a coil component and a manufacturing method thereof that have advantages of less noise and more simplified structure.

To achieve the above objective, a manufacturing method of a coil component of the invention comprises the steps of providing a first permeance element; sticking a strip-like element to a first area of a first surface of the first permeance element; providing a second permeance element; disposing a winding structure between the first permeance element and the second permeance element, or around at least one of the first permeance element and the second permeance element; and connecting the first permeance element and the second permeance element by a connecting material stuck to a second area, which is without the strip-like element, of the first surface.

To achieve the above objective, a coil component of the invention is made by the manufacturing method as mentioned above.

To achieve the above objective, a coil component of the invention comprises a first permeance element, a second permeance element, a winding structure, at least one strip-like element, and a connecting material. The first permeance element has a first surface having a first area and a second area. The second permeance element has a second surface facing the first surface. The winding structure is disposed between the first permeance element and the second permeance element, or around at least one of the first permeance element and the second permeance element. The strip-like element has at least one sticky surface stuck to the first area. The connecting material is at least stuck to the second area, and connects the first surface and the second surface.

In one embodiment, the first area is perpendicular to the second area.

In one embodiment, the second permeance element includes an edge-protruding portion facing the second area, and the connecting material sticks the edge-protruding portion and the second area.

In one embodiment, the second permeance element comprises a center-protruding portion, the winding structure is disposed around the center-protruding portion, and the connecting material sticks the center-protruding portion and the center of the first surface.

In one embodiment, another strip-like element is stuck to a third area of the first surface. The connecting material is stuck to the second area and a fourth area, which are without the strip-like element, of the first surface. The third area is opposite to the first area, and the fourth area is opposite to the second area.

In one embodiment, the connecting material is disposed overlapping with the strip-like element.

In one embodiment, the strip-like element is a heat-resistant adhesive tape, and the connecting material is a resin.

In one embodiment, the first permeance element and the second permeance element are iron cores.

In one embodiment, the winding structure includes at least one winding.

In one embodiment, the winding structure includes a bracket.

As mentioned above, in the coil component and the manufacturing method thereof of the invention, the strip-like element is disposed at a part of the connecting area of the first permeance element and the second permeance element, and another part of the connecting area is without the strip-like element. In other words, not only the connecting material is disposed between the permeance elements, but also the strip-like is disposed to avoid the mutual contact of the permeance elements. Therefore, when the circuit board on which the coil component of the invention is disposed operates, the strip-like element can effectively prevent the permeance elements from colliding with each other to solve the noise problem, even if the permeance elements of the coil component bear the alternate attraction and repulsion repeatedly due to the electromagnetic field.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a conventional coil component during the manufacturing process;

FIG. 1B is a schematic diagram of the coil component as shown in FIG. 1A;

FIG. 2 is a flow chart of a manufacturing method of a coil component according to a preferred embodiment of the invention;

FIGS. 3A to 3F are schematic diagrams of a manufacturing method of a coil component of a preferred embodiment of the invention;

FIGS. 4A and 4B are schematic diagrams of another aspect of the manufacturing method of the coil component according to the preferred embodiment of the invention;

FIGS. 5A to 5C are schematic diagrams of other aspects of the manufacturing method of the coil component according to the preferred embodiment of the invention;

FIG. 6 is a schematic diagram of a flat coil according to a preferred embodiment of the invention.

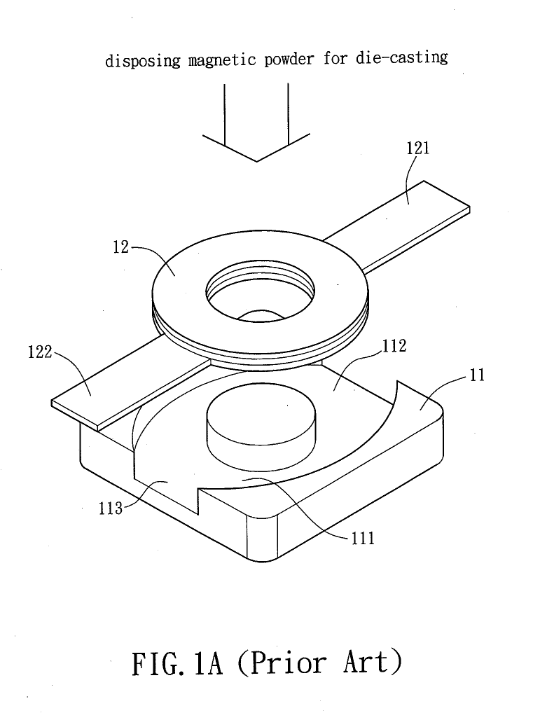

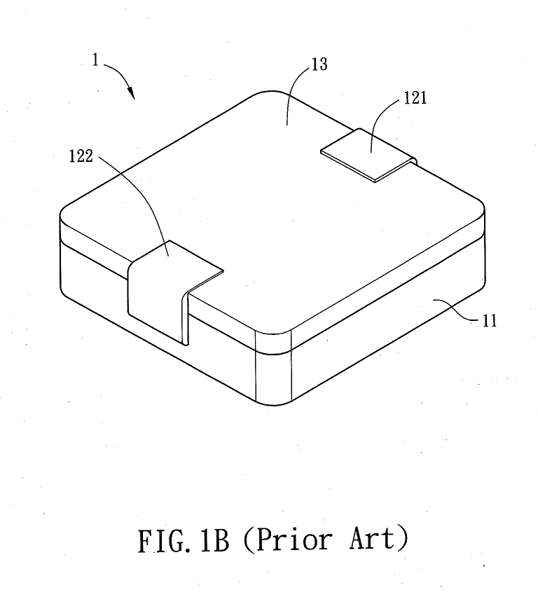

### DETAILED DESCRIPTION OF THE INVENTION

The present invention will be apparent from the following detailed description, which proceeds with reference to the accompanying drawings, wherein the same references relate to the same elements.

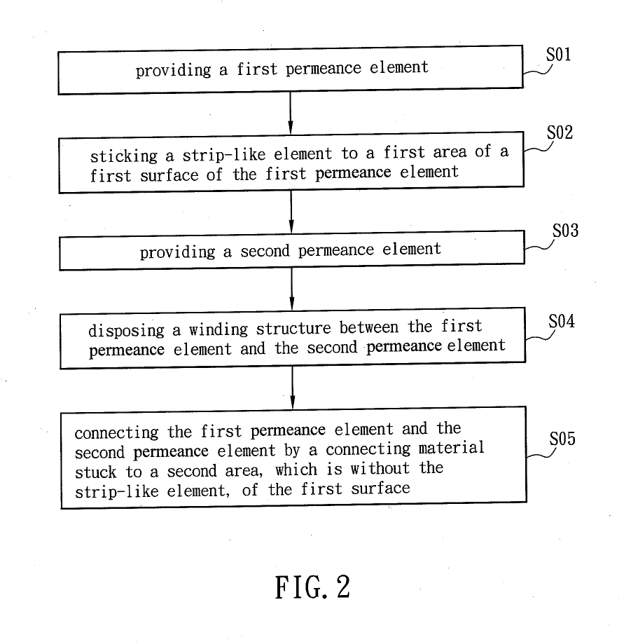

FIG. 2 is a flow chart of a manufacturing method of a coil component according to a preferred embodiment of the invention.

As shown in FIG. 2, the manufacturing method of the coil component includes the steps as follows:

The step S01 is to provide a first permeance element;

The step S02 is to stick a strip-like element to a first area of a first surface of the first permeance element;

The step S03 is to provide a second permeance element;

The step S04 is to dispose a winding structure between the first permeance element and the second permeance element; and

The step S05 is to connect the first permeance element and the second permeance element by a connecting material stuck to a second area, which is without the strip-like element, of the first surface. To be noted, in a preferred embodiment, the connecting material is also stuck to a part of the first area.

The first permeance element and the second permeance element are separate pieces before the mutual connection, and besides, the strip-like element will diminish the effectiveness of the mutual connection. Nevertheless, in the embodiment, the strip-like element is stuck to a part of the connecting area of the first permeance element and the second permeance element, and another part of the connecting area is without the strip-like element. Thus, because the strip-like element is disposed to the partial, but not whole, connecting area of the first permeance element and the second permeance element, the coil component of the embodiment can reduce the noise by using the strip-like element and also keep the connecting strength of the connecting material.

Therefore, when the circuit board configured with the coil component of the embodiment operates, the strip-like element can effectively prevent the permeance elements from colliding with each other to solve the noise problem, even if the permeance elements of the coil component bear the alternate attraction and repulsion repeatedly due to the electromagnetic field. Compared with the conventional art, the coil component of the embodiment has the advantages of less noise and less vibration.

Besides, the winding structure has at least one winding wire, which can be, but not limited to, an enameled wire. The enameled wire usually has a circle cross-section, and includes a conducting wire inside and an insulating body covering the conducting wire. Besides, the winding wire also can be a wire with a rectangle or flat cross-section. Two ends of the winding material can be electrically connected to the external circuit, such as the circuit for connecting a circuit board.

The strip-like element has a flat shape, and can be, but not limited to, a heat-resistant adhesive tape. The coil component is usually disposed on the circuit board by soldering, such as reflow soldering. Because the soldering process generates high temperature, the strip-like element will melt if it is insufficient in resisting the heat, so that the coil component and even the circuit board will be damaged. Therefore, using the heat-resistant adhesive tape as the strip-like element can overcome the above drawback.

The first and second permeance elements are iron cores, mainly including magnetic material. Besides the magnetic powder serving as the main composition of the first and second permeance elements, the thermosetting resin can be used to serve as the insulating material for decreasing the core loss caused by the Eddy current loss. The magnetic material and the thermosetting resin can be mixed and treated by a curing process to form the first and second permeance elements.

The following is the manufacturing method of the coil component illustrated by referring to the figures.

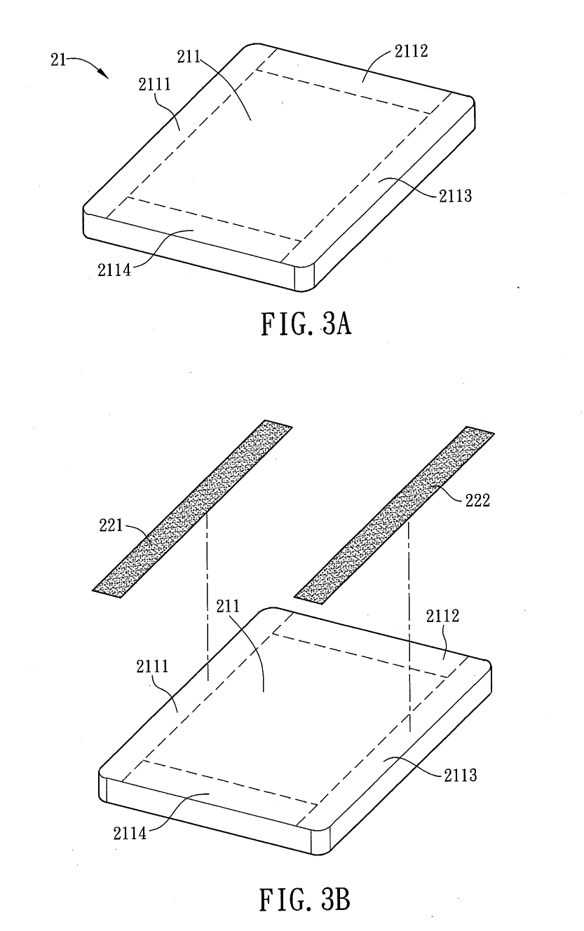

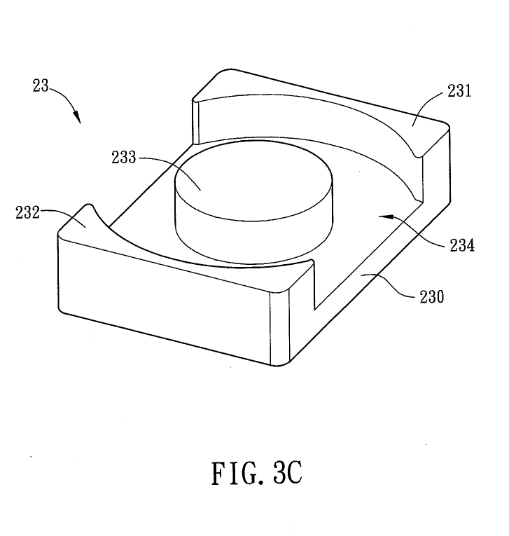

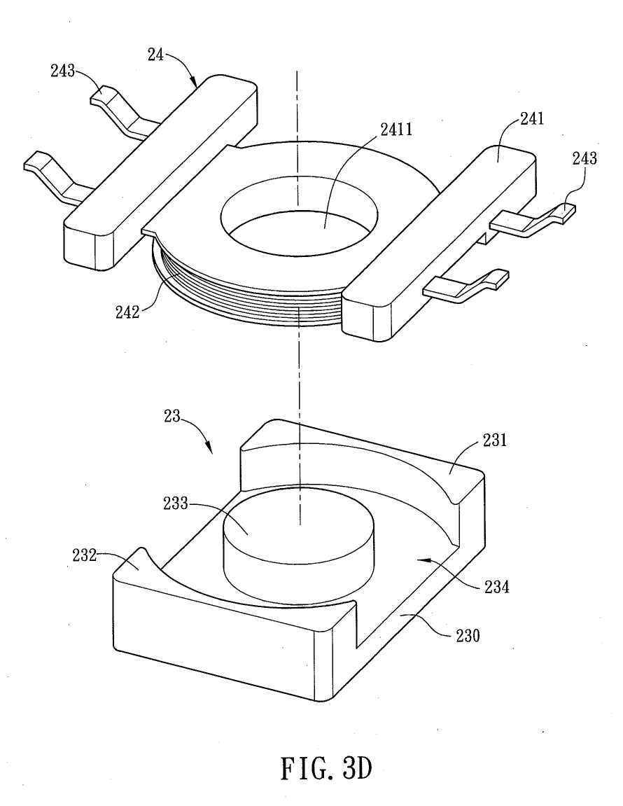

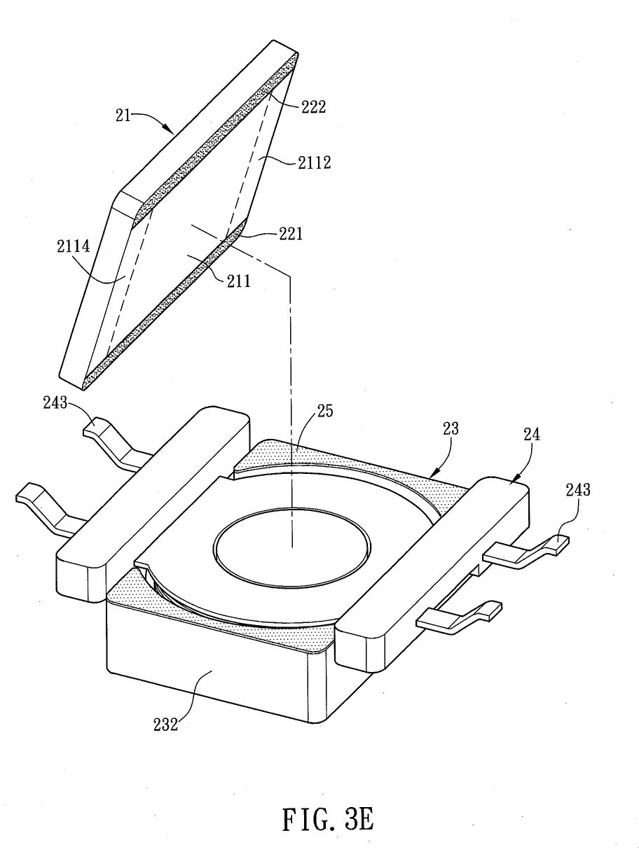

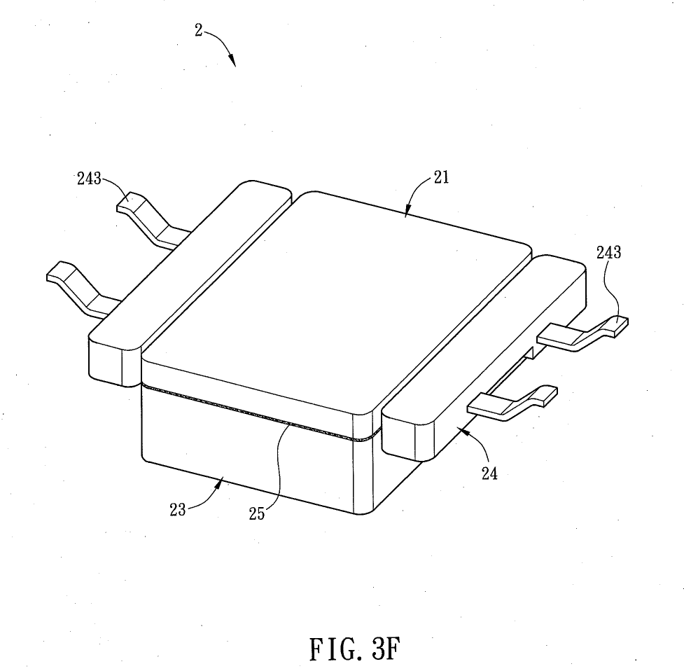

FIGS. 3A to 3F are schematic diagrams of a manufacturing method of a coil component of a preferred embodiment of the invention.

As shown in FIG. 3A, a first permeance element 21 is provided with a plate shape, such as a rectangle. In the embodiment, the first surface 211 of the first permeance element 21 includes a first area 2111, a second area 2112, a third area 2113, and a fourth area 2114. All of the areas 2111 to 2114 are approximately located at the edges respectively, and the third area 2113 is opposite to the first area 2111 while the fourth area 2114 is opposite to the second area 2112. Besides, the first area 2111 is perpendicular to the second area 2112, and the third area 2113 is perpendicular to the fourth area 2114. The first area 2111 and the third area 2113 are for sticking the strip-like element, and the second area 2112 and the fourth area 2114 are not for sticking the strip-like element. Besides, the second area 2112 and the fourth area 2114 are connected to the second permeance element 23 by the connecting material.

As shown in FIG. 3B, the strip-like elements 221 and 222 are stuck to the first area 2111 and the third area 2113 of the first surface 211 of the first permeance element 21 respectively, and the second area 2112 and the fourth area 2114 are kept without the strip-like element. In the embodiment, the strip-like elements 221 and 222 are strips covering the whole first area 2111 and third area 2113. Accordingly, it will become easier to stick the strip-like elements 221 and 222 to the first area 2111 and the third area 2113.

The strip-like elements 221 and 222 can be stuck to the first area 2111 and the third area 2113 at the same time or at the different time.

Then, as shown in FIG. 3C, the manufacturing method includes the step to provide a second permeance element 23 including a base portion 230, two edge-protruding portions 231 and 232, and a center-protruding portion 233. The edge-protruding portions 231 and 232 are disposed at two opposite edges of the base portion 230, and the center-protruding portion 233 is disposed at the center of the base portion 230. In a side view, the second permeance element 230 seems like the letter “E”. A containing room 234 is formed among the base portion 230, the edge-protruding portions 231 and 232, and the center-protruding portion 233, for containing a winding structure.

As shown in FIG. 3D, a winding structure 24 is disposed in the containing room 234 of the second permeance element 23 and around the center-protruding portion 233. The winding structure 24 includes a bracket 241 and at least one winding 242. The bracket 241 has a hole 2411 at its center, and the center-protruding portion 233 is passed through the hole 2411. The winding 242 is formed by winding a wire around the axial direction of the hole 2411. The winding 242 can be an enameled wire or a flat wire. In the embodiment, the pins 243 of the winding structure 24 are extended outwards at the side of the first permeance element 21. In the embodiment, there are two windings 242 and four pins 243. The two ends of each of the windings 242 are respectively connected with the two pins at the same side. After being manufactured, the coil component 2 can serve as a transformer.

As shown in FIG. 3E, a connecting material 25 for connecting the first permeance element 21 and the second permeance element 23 is stuck to the second area 2112 and the fourth area 2114, which are without the strip-like elements 221 and 222, of the first surface 211. Besides, the connecting material 25 is also disposed overlapping with a part of the strip-like elements 221 and 222. In the embodiment, the connecting material 25 is first stuck onto the second surface (here indicating the top surfaces of the edge-protruding portions 231 and 232), which is corresponding the second area 2112 and the fourth area 2114, and then stuck onto the second area 2112 and the fourth area 2114 after the assembly.

In the embodiment, the edge-protruding portions 231 and 232 are disposed facing the second area 2112 and the fourth area 2114 respectively, and the connecting material 25 sticks the edge-protruding portion 231 to the second area 2112 and sticks the edge-protruding portion 232 to the fourth area 2114. Besides, the connecting material 25 also sticks the center-protruding portion 233 to the center of the first surface 211.

As shown in FIG. 3F, after the connecting material 25 connects the first permeance element 21 to the second permeance element 23, the winding structure 24 is disposed between the first permeance element 21 and the second permeance element 23. To be noted, the strip-like element is disposed at the partial sticking surfaces of the first permeance element 21 and the second permeance element 23, and the sticking surfaces thereof are connected to each other mainly by the connecting material 25.

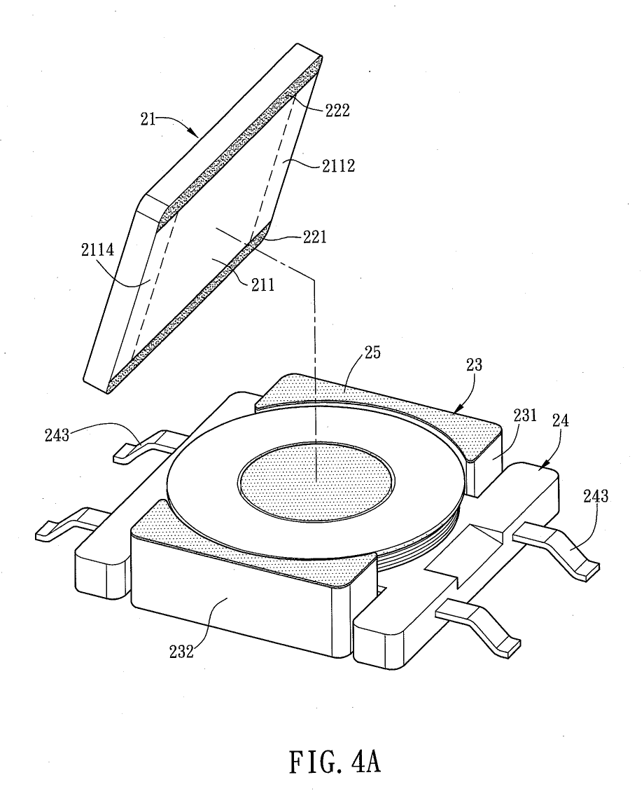

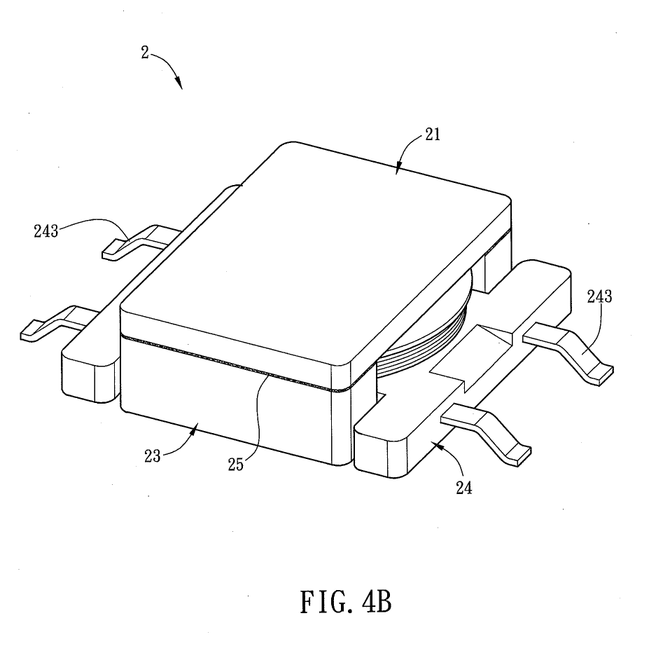

FIGS. 4A and 4B are schematic diagrams of another aspect of the manufacturing method of the coil component according to the preferred embodiment of the invention. As shown in FIGS. 4A and 4B, the pins 243 of the winding structure 24 are extended outwards at the side of the second permeance element 23. Because the other features of this aspect are similar to the embodiment as shown in FIGS. 3D to 3F, the detailed descriptions are omitted here.

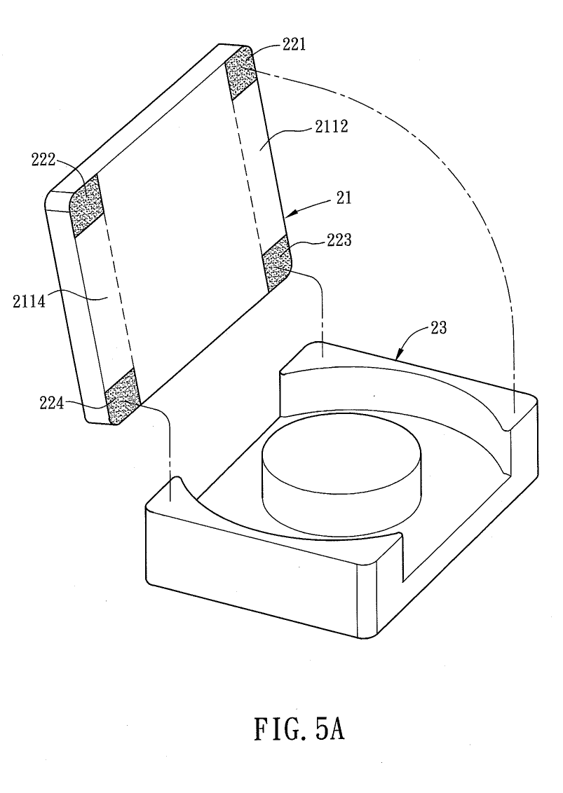

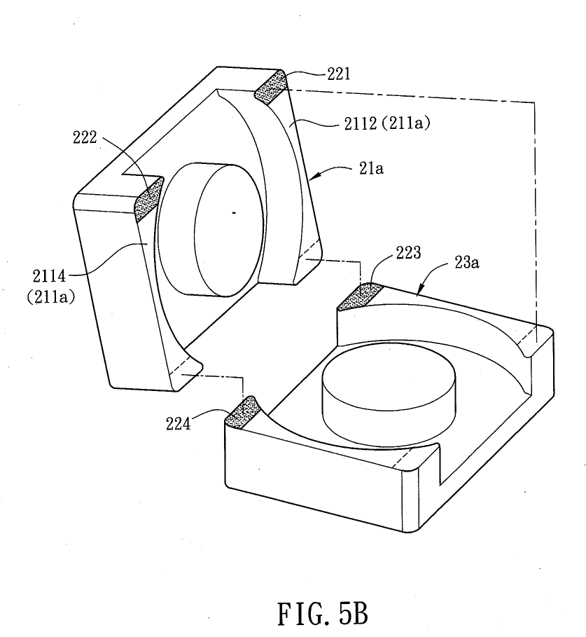

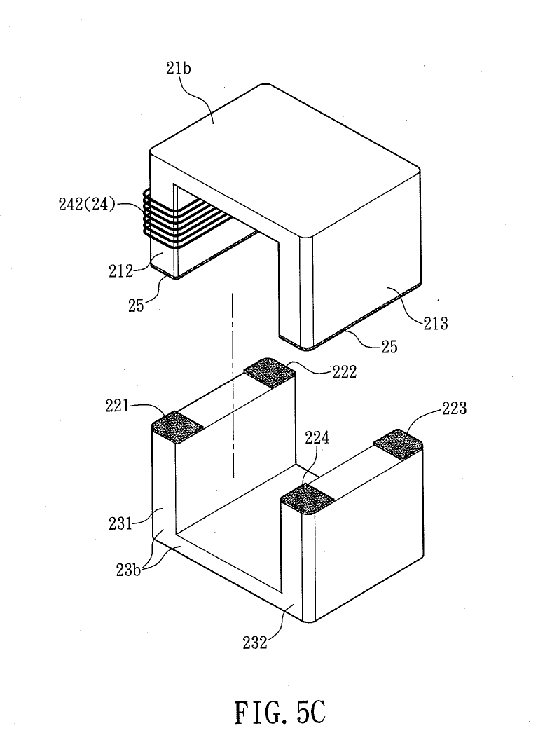

FIGS. 5A and 5B are schematic diagrams of other aspects of the manufacturing method of the coil component according to the preferred embodiment of the invention. As shown in FIGS. 5A and 5B, the first permeance element with the strip-like element and the second permeance element can have several variations.

As shown in FIG. 5A, the first permeance element 21 is still provided with a plate shape, such as a rectangle, and the second permeance element 23 seems like the letter “E” in a side view. The strip-like elements 221 to 224 are separately stuck to the four corners of the first permeance element 21. The second area 2112 and the fourth area 2114 of the first surface 211 are still without the strip-like element, and connected to the second permeance element 23 by the connecting material. Because the other elements and the manufacturing method of the coil component as shown in FIG. 5A are the same as or similar to the above embodiments, the detailed descriptions are omitted here.

As shown in FIG. 5B, the first permeance element 21a and the second permeance element 23a both seem like the letter “E” in a side view, so they are connected to each other like the combination of an “E” and an inverted “E”. The strip-like element 221 and 222 are stuck to the partial area of the first surface 211a which is protruding to connect the second permeance element 23. The second area 2112 of the first surface 211a is without the strip-like element.

Otherwise, the two permeance elements can both have the strip-like elements. As shown in FIG. 5B, the strip-like elements 221 and 222 are disposed on the first permeance element 21a, and the strip-like elements 223 and 224 are disposed on the second permeance element 23a. To be noted, the second area 2112 and the fourth area 2114 of the first surface of the first permeance element 21a are still without the strip-like elements, and similarly, the areas of the second permeance element 23a corresponding to the second area 2112 and the fourth area 2114 are also without strip-like elements. The areas without strip-like elements as mentioned above are connected to each other directly by the connecting material. Because the other elements and the manufacturing method of the coil component as shown in FIG. 5B are the same as or similar to the above embodiments, the detailed descriptions are omitted here.

As shown in FIG. 5C, the first permeance element 21b and the second permeance element 23b both seem like the letter “U” in a side view. The winding structure 24 is formed on at least one of the first permeance element 21b and the second permeance element 23b. In the embodiment, the winding structure 24 includes at least one winding 242 which is formed around an edge-protruding portion 212 of the first permeance element 21b. The winding structure 24 can further include another winding which is formed around another edge-protruding portion 213 of the first permeance element 21b. Besides, two windings 242 also can be formed around the edge-protruding portions 231 and 232 of the second permeance element 23b. Or, several windings 242 of the winding structure 24 can be formed around the edge-protruding portions 212, 213, 231, and 232 of the first and second permeance elements 21b and 23b respectively.

The first permeance element 21b and the second permeance element 23b can have the strip-like elements 221 to 224, such as FIGS. 3A to 3C. After the winding structure 24 is formed on the first permeance element 21b or the second permeance element 23b, first permeance element 21b and the second permeance element 23b can be connected by the connecting material 25, such as FIGS. 3E and 3F or FIGS. 4A and 4B. Besides, the partial connecting material 25 is disposed on the strip-like elements 221 to 224. Because the other elements and the manufacturing method of the coil component as shown in FIG. 5C are the same as or similar to the above embodiments, the detailed descriptions are omitted here.

As mentioned above, the first permeance element and the second permeance element can have a plate shape, an “E” shape, or a “U” shape. The first permeance element and the second permeance element can have the same shape or different shape. For example, the first permeance element is plate-shaped, and the second permeance element is “E”-shaped.

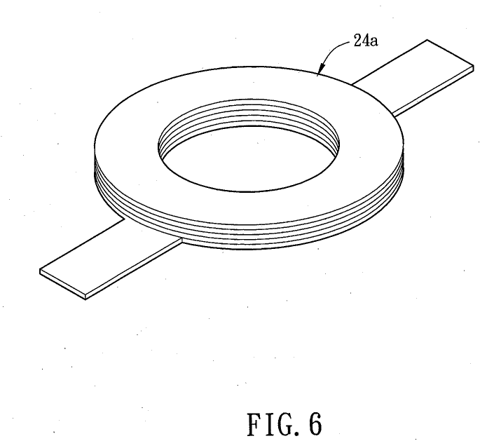

Besides, the winding structure in the all above embodiments can be a pure coil. For example, as shown in FIG. 6, the winding structure 24a is a flat coil with a rectangular cross-section. Besides, it has two ends serving as the electrode pins. In the embodiment, the whole coil component can serve as an inductor.

As shown in FIGS. 3E and 3F, a coil component 2 according to a preferred embodiment of the invention includes a first permeance element 21, a second permeance element 23, a winding structure 24, at least one strip-like element 22, and a connecting material 25. The first permeance element 21 has a first surface 211 which has a first area 2111 and a second area 2112. The second permeance element 23 has a second surface (here indicating the top surfaces of the edge-protruding portions 231 and 232) facing the first surface 211. The winding structure 24 is disposed between the first surface 211 and the second surface. The strip-like element 221 has at least one sticky surface to stick the first area 2111. The connecting material 25 is at least stuck to the second area 2112 to connect the first surface 211 and the second surface. The coil component 2 can be made by the manufacturing method as mentioned above, and the variations thereof have been illustrated in the above embodiments, so the detailed descriptions are omitted here.

In summary, in the coil component and the manufacturing method thereof of the invention, the strip-like element is disposed at a part of the connecting area of the first permeance element and the second permeance element, and another part of the connecting area is without the strip-like element. In other words, not only the connecting material is disposed between the permeance elements, but also the strip-like is disposed to avoid the mutual contact of the permeance elements. Therefore, when the circuit board on which the coil component of the invention is disposed operates, the strip-like element can effectively prevent the permeance elements from colliding with each other to solve the noise problem, even if the permeance elements of the coil component bear the alternate attraction and repulsion repeatedly due to the electromagnetic field.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of a coil component, comprising:
providing a first permeance element;
sticking a strip-like element into a first area of a first surface of the first permeance element;
providing a second permeance element;
disposing a winding structure between the first permeance element and the second permeance element or around at least one of the first permeance element and the second permeance element; and
connecting the first permeance element and the second permeance element by a connecting material stuck to a second area, which is without the strip-like element, of the first surface.

2. The manufacturing method as recited in claim 1, wherein the first area is perpendicular to the second area.

3. The manufacturing method as recited in claim 1, wherein the second permeance element comprises an edge-protruding portion facing the second area, and the connecting material sticks the edge-protruding portion and the second area.

4. The manufacturing method as recited in claim 1, wherein the second permeance element comprises a center-protruding portion, the winding structure is disposed around the center-protruding portion, and the connecting material sticks the center-protruding portion and the center of the first surface.

5. The manufacturing method as recited in claim 1, further comprising:
sticking another strip-like element to a third area of the first surface, wherein the connecting material is stuck to the second area and a fourth area, which are without the strip-like element, of the first surface, the third area is opposite to the first area, and the fourth area is opposite to the second area.

6. The manufacturing method as recited in claim 1, wherein the connecting material is disposed overlapping with the strip-like element.

7. The manufacturing method as recited in claim 1, wherein the strip-like element is a heat-resistant adhesive tape, and the connecting material is a resin.

8. The manufacturing method as recited in claim 1, wherein the first permeance element and the second permeance element are iron cores.

9. The manufacturing method as recited in claim 1, wherein the winding structure includes at least one winding.

10. A coil component, comprising:
a first permeance element having a first surface which has a first area and a second area;
a second permeance element having a second surface facing the first surface;
a winding structure disposed between the first permeance element and the second permeance element, or around at least one of the first permeance element and the second permeance element;
at least one strip-like element having at least one sticky surface which is stuck to the first area; and
a connecting material at least stuck to the second area and connecting the first surface and the second surface.

11. The coil component as recited in claim 10, wherein the second area is without the strip-like element.

12. The coil component as recited in claim 10, wherein the first area is perpendicular to the second area.

13. The coil component as recited in claim 10, wherein the second permeance element includes an edge-protruding portion facing the second area, and the connecting material sticks the edge-protruding portion and the second area.

14. The coil component as recited in claim 10, wherein the second permeance element includes a center-protruding portion, the winding structure is disposed around the center-protruding portion, and the connecting material sticks the center-protruding portion and the center of the first surface.

15. The coil component as recited in claim 10, wherein the first surface has a third area opposite to the first area and a fourth area opposite to the second area, the strip-like elements are disposed to the first area and the third area, the connecting material is stuck to the second area and the fourth area, and the second area and the fourth area are without the strip-like elements.

16. The coil component as recited in claim 10, wherein the connecting material is disposed overlapping with the strip-like element.

17. The coil component as recited in claim 10, wherein the strip-like element is a heat-resistant adhesive tape, and the connecting material is a resin.

18. The coil component as recited in claim 10, wherein the first permeance element and the second permeance element are iron cores.

19. The coil component as recited in claim 10, wherein the winding structure includes a bracket and a winding.
